(19) United States
(12) Patent Application Publication
(10) Pub. No.: US 2026/0289054 A1
(43) Pub. Date: Sep. 24, 2026

(54) CFD NUMERICAL COMPUTATIONAL METHOD FOR FLUTTER RESPONSES OF LONG-SPAN BRIDGES IN NONLINEAR GEOMETRIC STIFFNESS CONDITIONS

(71) Applicant: DALIAN UNIVERSITY OF TECHNOLOGY, Dalian (CN)

(72) Inventors: Fuyou XU, Dalian (CN); Lixin ZHANG, Dalian (CN); Wanbo AN, Dalian (CN); Zhanbiao ZHANG, Dalian (CN); Mingjie ZHANG, Dalian (CN); Pinqing WANG, Dalian (CN)

(21) Appl. No.: 19/683,406

(22) Filed: May 20, 2026

(30) Foreign Application Priority Data
Dec. 3, 2025 (CN) 202511807751.9

(51) Int. Cl. G06F 30/28; G06F 30/13; G06F 30/23; G06F 111/10; G06F 119/14

(52) U.S. Cl. CPC G06F 30/28; G06F 30/13; G06F 30/23; G06F 2111/10; G06F 2119/14

(57) ABSTRACT

The present invention belongs to the technical field of bridge wind-induced vibration analysis, and discloses a CFD numerical computational method for flutter responses of long-span bridges in nonlinear geometric stiffness conditions. In the method, nonlinear geometric stiffnesses are embedded into motion equations of a girder in real time, and fluid-structure interaction (FSI) computation is conducted with a flow field, thus to achieve dynamic correlation between the displacements and the geometric stiffnesses of the girder, and accurately solve the nonlinear flutter responses of the bridge under wind-induced excitation. Compared with the assumption of constant geometric stiffnesses in traditional CFD simulation, the computing mode of the present invention is more reasonable and the accuracy is higher. Compared with a wind tunnel test, the present invention can flexibly adjust any form of geometric nonlinear stiffness parameters without the need of complex nonlinear simulation devices.

### TECHNICAL FIELD

The present invention belongs to the technical field of bridge wind-induced vibration analysis, which relates to the methods for fluid-structure interaction (FSI) between bridge girders and wind fields, nonlinear geometric stiffnesses, aerodynamic nonlinear flutter stability analysis, etc., and particularly relates to a computational fluid dynamics (CFD) method for wind-induced nonlinear flutter dynamic response of bridges considering the variation of geometric stiffnesses with displacements.

### BACKGROUND

In the existing flutter analysis of long-span bridges, it is usually held that the geometric stiffnesses of a structure remain unchanged in a vibration process, which has certain applicability in the conditions of small displacements and amplitudes. However, when a bridge structure is subjected to a strong wind excitation and experiences significant static wind-induced displacements and amplitudes, the geometric stiffnesses are no longer constant. If a constant stiffness model is still adopted, it will be difficult to accurately simulate the actual critical wind speed of flutter and the aerodynamic response of the bridge structure.

All the existing computational fluid dynamics (CFD) methods for studying the flutter responses of bridges are based on the assumption of constant geometric stiffnesses, which is inconsistent with the actual objective fact of nonlinear geometric stiffnesses. Such simulation methods meet the engineering requirements for the accuracy of short-span bridges and classical flutter, but for super-long-span flexible bridges with very large static wind-induced displacements and amplitudes, the simulation error is unacceptable.

Therefore, the present invention proposes to consider the factor of geometric stiffnesses varying with displacements in CFD flutter computation, introduce relevant nonlinear stiffness characteristics, achieve real-time correlation between geometric stiffnesses and displacements, and truly simulate the wind-induced large displacements and significant vibration behaviors of the bridge structure. Compared with the traditional assumption of constant geometric stiffnesses, the method of the present invention can describe the influence of the softening or hardening effect of the geometric stiffnesses on vibration frequency, response amplitude and stability boundary, thereby improving the accuracy of flutter analysis results.

### SUMMARY

The present invention proposes a CFD numerical computational method for flutter of long-span bridges in simulated non-constant geometric stiffness conditions. The method introduces the nonlinear characteristic that geometric stiffnesses vary with displacements in the numerical computation of wind-induced flutter of bridges. Compared with traditional simulation methods where the geometric stiffnesses are assumed to be constant, the method of the present invention can truly reflect the variation law of the overall geometric stiffness of a structure with displacements, and is close to the real dynamic characteristics of the bridges, providing a more reliable and accurate numerical analysis means for flutter mechanism studying and wind resistance design of bridges.

The technical solution of the present invention is as follows:

A CFD numerical computational method for flutter responses of long-span bridges in nonlinear geometric stiffness conditions, taking two-dimensional simulation as an example, comprises the following steps:

Step 1: establishing a three-dimensional finite element model of a bridge, and establishing a nonlinear geometric stiffness model based on computational analysis; and specifically: establishing a functional relation between lateral geometric stiffness Kₓ(x,t) and lateral displacement x(t), a functional relation between vertical geometric stiffness K_{y}(y,t) and vertical displacement y(t), and a functional relation between torsional geometric stiffness K_{α}(α,t) and torsional displacement a(t) of the bridge;
Step 2: determining dynamic parameters of a bridge girder, including equivalent mass, moment of inertia and natural frequency, and determining geometric scale ratio, vibration frequency ratio and wind velocity ratio of a girder rigid model;
Step 3: establishing coupling motion equations of lateral, vertical and torsional degrees of freedom of the girder rigid model in a wind field; and during the motion of the bridge girder, dynamically adjusting the lateral geometric stiffness Kₓ(x,t), the vertical geometric stiffness K_{y}(y,t) and the torsional geometric stiffness K_{α}(α,t) with changes in time and displacements;
Step 4: constructing a state equation to provide a computational basis for subsequent numerical integration solution and real-time update of the geometric stiffnesses varying with displacements;
Step 5: establishing a geometric model of the bridge girder, determining the size and boundary conditions of a flow field computational domain, dividing flow field meshes, and reading the aerodynamic forces acting on the bridge girder and the probe position of a flow field in each flow field mesh cell;
Step 6: importing the flow field meshes divided in step 5 into Fluent software, and embedding the state equation of nonlinear dynamic behaviors of the bridge girder and the nonlinear geometric stiffness model into the solver of the Fluent software by user defined functions (UDF) to achieve fluid-structure interaction (FSI) solution of the bridge girder and the wind field.

The specific process is as follows:
1) At the beginning of each time step, computing the lateral geometric stiffness Kₓ(x,t), the vertical geometric stiffness K_{y}(y,t) and the torsional geometric stiffness K_{α}(α,t) based on the displacements and velocities of the bridge girder at the current time t, updating the state equation (13), and reading updated lateral displacement, vertical displacement and torsional displacement of the bridge, thus to achieve the real-time variation of the nonlinear geometric stiffnesses with displacements;
2) Using updated lateral geometric stiffness, vertical geometric stiffness and torsional geometric stiffness as well as the aerodynamic forces to solve the state equation of the bridge girder, and using a fourth order Runge-Kutta method to perform time-marching on the displacements and velocities;
3) Updating the position of the bridge girder and automatically adjusting the meshes of a wind field computational domain to maintain the consistency of fluid-structure interaction (FSI);
Step 7: at the initial stage of computation, keeping the bridge girder in a stationary state to ensure that the flow field is fully developed and reaches a stable distribution; subsequently, applying an initial displacement excitation to the bridge girder as an initial condition of a free vibration stage; and in the free vibration stage, repeating step 6 for the bridge girder at each time step to solve the nonlinear flutter response time history of the bridge girder after excitation, thus to achieve numerical analysis of wind-induced flutter characteristics of the nonlinear geometric stiffnesses of the bridge.

Further, the “step 3: establishing coupling motion equations of lateral, vertical and torsional degrees of freedom of the girder rigid model in a wind field” is expressed as:

$$m \ddot{x} ( t ) + {C}_{x 0} \dot{x} ( t ) + {K}_{x 0} x ( t ) = {F}_{x} ( t ) \qquad ( 1 )$$

$$m \ddot{y} ( t ) + {C}_{y 0} \dot{y} ( t ) + {K}_{y 0} y ( t ) = {F}_{y} ( t ) \qquad ( 2 )$$

$$I \ddot{α} ( t ) + {C}_{α0} \dot{α} ( t ) + {K}_{α0} α ( t ) = M ( t ) \qquad ( 3 )$$

where m and I are respectively the equivalent mass and the moment of inertia of the girder rigid model; x(t), y(t) and a(t) are respectively the lateral displacement, the vertical displacement and the torsional displacement; x(t), y(t) and α(t) are respectively the lateral velocity, the vertical velocity and the torsional angular velocity; \dot{x}(t), \dot{y}(t) and \dot{α}(t) are respectively the lateral acceleration, the vertical acceleration and the torsional angular acceleration; Fₓ(t), F_{y}(t) and M(t) are respectively the aerodynamic forces in the lateral and vertical directions and the aerodynamic moment in the torsional direction; Cₓ₀, C_{y0} and C_{α0} are respectively the damping coefficients in the lateral, vertical and torsional directions; Kₓ₀, K_{y0} and K_{α0} are respectively the initial stiffnesses in the lateral, vertical and torsional directions; and the expressions are as follows:

$${C}_{x 0} = 2 m \cdot {ω}_{x 0} \cdot {ξ}_{x 0} \qquad ( 4 )$$

$${C}_{y 0} = 2 m \cdot {ω}_{y 0} \cdot {ξ}_{y 0} \qquad ( 5 )$$

$${C}_{α0} = 2 I \cdot {ω}_{α0} \cdot {ξ}_{α0} \qquad ( 6 )$$

$${K}_{x 0} = m {ω}_{x 0}^{2} \qquad ( 7 )$$

$${K}_{y 0} = m {ω}_{y 0}^{2} \qquad ( 8 )$$

$${K}_{α0} = I {ω}_{α0}^{2} \qquad ( 9 )$$

where ωₓ₀, ω_{y0} and ω_{α0} are respectively the natural frequencies in the lateral, vertical and torsional directions; and ξₓ₀, ξ_{y0} and ξ_{α0} are respectively the mechanical damping ratios in the lateral, vertical and torsional directions;
During the motion of the bridge girder, dynamically adjusting the lateral geometric stiffness Kₓ(x,t), the vertical geometric stiffness K_{y}(y,t) and the torsional geometric stiffness K_{α}(α,t) with changes in time and displacements;
Computing the lateral displacement x(t), the vertical displacement y(t) and the torsional displacement α(t) in the user defined functions (UDF) in real time, and dynamically updating the lateral geometric stiffness Kₓ(x,t), the vertical geometric stiffness K_{y}(y,t) and the torsional geometric stiffness K_{α}(α,t) to achieve real-time adjustment of the geometric stiffnesses with changes in displacements;
Replacing the initial stiffnesses Kₓ₀, K_{y0} and K_{α0} in the lateral, vertical and torsional directions in equations (1), (2) and (3) with the nonlinear lateral, vertical and torsional geometric stiffnesses Kₓ(x,t), K_{y}(y,t) and K_{α}(α,t) considering the variation of the geometric stiffnesses with changes in time and displacements, and rewriting equations (1), (2) and (3) as:

$$\ddot{x} ( t ) = [ {F}_{x} ( t ) - {C}_{x 0} \dot{x} ( t ) - {K}_{x} ( x , t ) x ( t ) ] / m \qquad ( 10 )$$

$$\ddot{y} ( t ) = [ {F}_{y} ( t ) - {C}_{y 0} \dot{y} ( t ) - {K}_{y} ( y , t ) y ( t ) ] / m \qquad ( 11 )$$

$$\ddot{α} ( t ) = [ M ( t ) - {C}_{α0} \dot{α} ( t ) - {K}_{α} ( α , t ) α ( t ) ] / I \qquad ( 12 )$$

Further, the specific method for constructing a state equation in step 4 is as follows:

Letting X(t)=[x(t), y(t), α(t), \dot{x}(t), \dot{y}(t), \dot{α}(t)]^{T}, and rewriting the second order differential equations (10), (11) and (12) as the following first order differential equation:

$$\dot{X} ( t ) = ( \begin{matrix}\dot{x} ( t ) \\ \dot{y} ( t ) \\ \dot{α} ( t ) \\ \ddot{x} ( t ) \\ \ddot{y} ( t ) \\ \ddot{α} ( t )\end{matrix} ) = ( \begin{matrix}0 & 0 & 0 & 1 & 0 & 0 \\ 0 & 0 & 0 & 0 & 1 & 0 \\ 0 & 0 & 0 & 0 & 0 & 1 \\ - \frac{{K}_{x} ( x , t )}{m} & 0 & 0 & - \frac{{C}_{x 0}}{m} & 0 & 0 \\ 0 & - \frac{{K}_{y} ( y , t )}{m} & 0 & 0 & - \frac{{C}_{y 0}}{m} & 0 \\ 0 & 0 & - \frac{{K}_{α} ( α , t )}{I} & 0 & 0 & - \frac{{C}_{α 0}}{I}\end{matrix} ) ( \begin{matrix}x ( t ) \\ y ( t ) \\ α ( t ) \\ \dot{x} ( t ) \\ \dot{y} ( t ) \\ \dot{α} ( t )\end{matrix} ) + {( \begin{matrix}0 & 0 & 0 & \frac{{F}_{x} ( t )}{m} & \frac{{F}_{y} ( t )}{m} & \frac{M ( t )}{I}\end{matrix} )}^{T} = AX ( t ) + B \qquad ( 13 )$$

Equation (13) is the state equation describing the nonlinear dynamic behaviors of the bridge girder in the wind field; and in a numerical simulation process, after the aerodynamic forces and aerodynamic torque acting on the bridge girder in each time step are obtained, a fourth order Runge-Kutta numerical integration algorithm is adopted based on the state equation to solve the time-domain evolution of a system state, and displacement responses x(t), y(t) and α(t) as well as velocity responses \dot{x}(t), \dot{y}(t) and \dot{α}(t) of the bridge girder under wind-induced excitation are obtained;
Further, the computational domain adopted in step 5 is a rectangular wind field region arranged around the bridge girder, and the boundary conditions are set, including setting a velocity inlet boundary, setting a pressure outlet boundary, setting upper and lower boundaries of the computational domain as symmetrical boundary conditions, and setting the surface of the bridge girder as a no-slip wall boundary, thus to ensure the physical closure of flow field solution; meshes of the computational domain adopt a mesh structure comprising a near-wall encrypted boundary layer region and a dynamic mesh region having position or shape updated with the motion of the bridge girder, thus to ensure that the flow field changes caused by the motion of the girder can be effectively captured; and the update of the dynamic mesh region is implemented by a mesh smoothing method. The above parameter settings are adjustable and can be reasonably selected and corrected based on bridge structural characteristics, wind field conditions and computational accuracy requirements.

In practical application, the method of the present invention can either adopt a two-dimensional rigid girder model or be extended to a three-dimensional rigid girder model to carry out CFD numerical simulation. Compared with the two-dimensional case, three-dimensional computation requires the construction of a three-dimensional computational domain including the length direction of the girder and the arrangement of meshes along the axial direction of the girder; and at the same time, corresponding three-dimensional boundary conditions and a turbulence model shall be set, and three-dimensional dynamic mesh technology shall be combined, thus to achieve real-time update of the spatial motion of the girder. Due to the need of processing larger-scale meshes and more complex flow structures, the computational load and resource requirements of three-dimensional simulation are significantly higher than those of the two-dimensional case.

Beneficial effects of the present invention: compared with the traditional CFD method based on the assumption of constant geometric stiffnesses, the present invention has the following beneficial effects: \textcircled{1} the present invention achieves the dynamic adjustment of geometric stiffnesses with displacements under fluid-structure interaction (FSI), which can more truly reflect the actual nonlinear dynamic characteristics of a bridge structure and improve the accuracy of flutter analysis; \textcircled{2} compared with a wind tunnel test method, the method of the present invention can flexibly adjust any form of geometric nonlinear stiffness parameters without the need of complex nonlinear simulation devices; and \textcircled{3} the present invention has wide engineering applicability, which can not only be used for the analysis of post-flutter of bridges, but also be extended to the analysis of wind-induced responses in other engineering projects with obvious nonlinear geometric stiffnesses.

### DESCRIPTION OF DRAWINGS

FIG. 1 is a flow chart of a method in an embodiment of the present invention.

FIG. 2 is a schematic diagram of a mechanical model of a girder system in a wind field in an embodiment of the present invention.

FIG. 3 is a model drawing of a girder in an embodiment of the present invention.

FIG. 4 is a schematic diagram of a wind field computational domain and boundary conditions in an embodiment of the present invention.

FIG. 5 is a flow field mesh division diagram of a wind field computational domain in an embodiment of the present invention: (a) overall computational domain region; (b) girder and surrounding region; (c) bridge central guardrail; (d) bridge side guardrail; (e) wind fairing.

FIG. 6 is a schematic diagram of a numerical simulation process of girder vibration in an embodiment of the present invention.

FIG. 7 shows a vertical flutter displacement time history curve of girders having constant geometric stiffnesses and having geometric stiffnesses varying with displacements in an embodiment of the present invention.

FIG. 8 shows a torsional flutter displacement time history curve of girders having constant geometric stiffnesses and having geometric stiffnesses varying with displacements in an embodiment of the present invention.

### DETAILED DESCRIPTION

A specific embodiment of the present invention is further described below in combination with the drawings and the technical solution.

### Embodiment

For a two-dimensional streamlined cross-section girder, model parameters are that: the width of the girder is 0.2485 m, the scale ratio to an actual bridge is 1:200, m=1.07696 kg/m, I=0.00645 kg·m²/m, ω_{y0}=1.42 Hz, ω_{α0}=3.14 Hz, ξ_{y0}=0.002, and ξ_{α0}=0.002. As the sensitivity of lateral stiffness of a bridge varying with displacement under wind-induced action is relatively low in the present embodiment and the influence on the overall flutter characteristics is limited, no nonlinear analysis of the lateral stiffness is conducted in the present embodiment, and only nonlinear vertical and torsional geometric stiffnesses are considered. The nonlinear vertical and torsional geometric stiffnesses K_{y}(y,t) and K_{α}(α,t) are respectively expressed as:

$${K}_{y} ( y , t ) = {K}_{y 0} ( 1 + {{β}_{y} ( \frac{y ( t )}{{y}_{r e f}} )}^{{n}_{y}} ) \qquad ( 14 )$$

$${K}_{α} ( α , t ) = {K}_{α0} ( 1 + {β}_{α} {\vert \frac{a ( t )}{{a}_{r e f}} \vert}^{{n}_{α}} ) \qquad ( 15 )$$

where β_{y} and β_{α} are nonlinear coefficients used for adjusting the variation of the geometric stiffnesses with vertical displacement and torsional displacement; y_{ref} is the reference vertical displacement, and α_{ref} is the reference torsional angle; n_{y} and n_{α} are nonlinear orders; and in the present embodiment, n_{y}=1 and n_{α}=2. The present embodiment adopts the above form only for illustrative purposes. In actual engineering, other mathematical forms or fitting functions can also be used to characterize the characteristics of the geometric stiffnesses of a structure varying with vibration responses, thus to meet the requirements of different bridge structures and designs. For the convenience of illustration, two different working conditions are designed in the embodiment of the present invention, and parameter settings of nonlinear geometric stiffnesses are shown in Table 1:

TABLE 1
Parameter working condition settings
of nonlinear geometric stiffnesses

| Working conditions | β_{y} | y_{ref} (m) | β_{α} | α_{ref} (rad) |
|---|---|---|---|---|
| Solution 1 | −0.01 | 0.005 | −0.05 | 0.1 |
| Solution 2 | −0.01 | 0.005 | 0.05 | 0.1 |

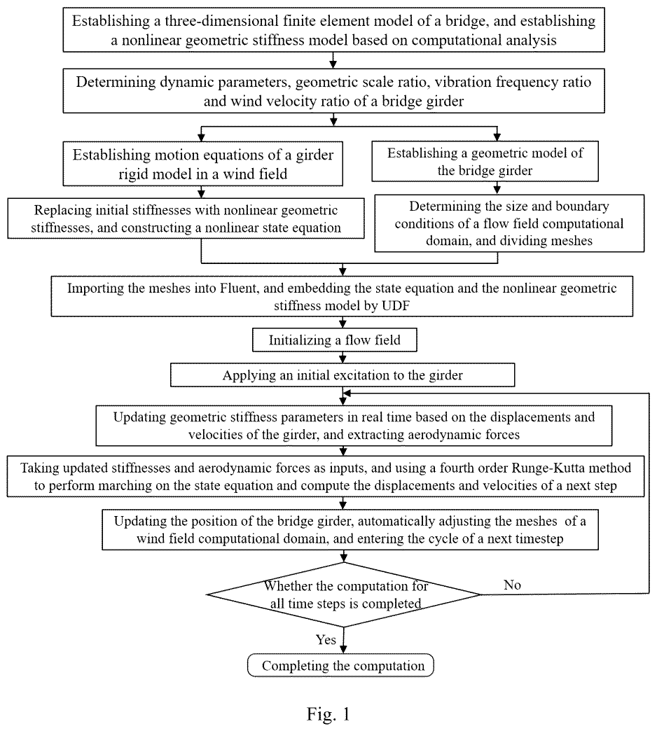

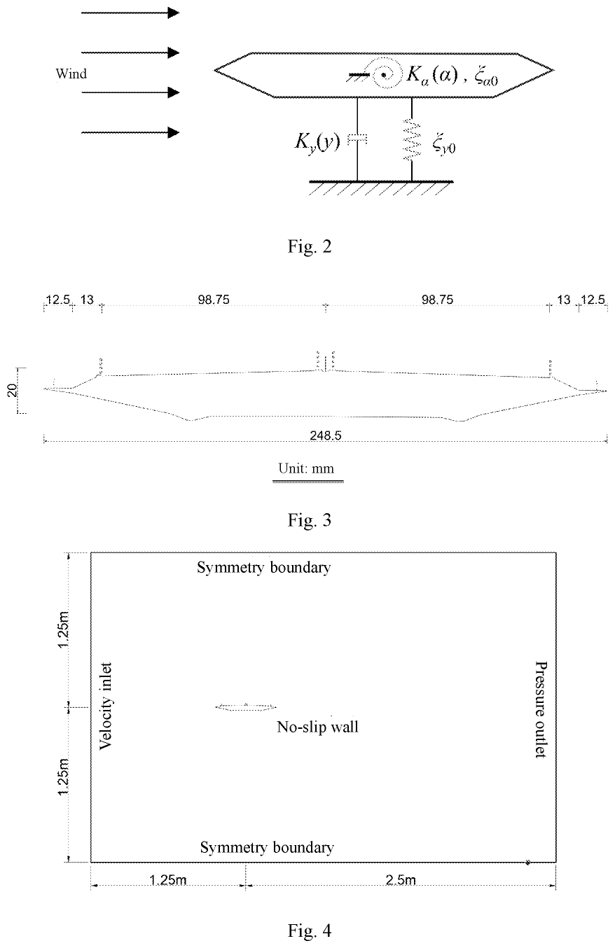

The flutter responses of a bridge girder in different conditions are obtained by the method of the present invention. An implementation flow chart is shown in FIG. 1, and specific operation steps are as follows:

Step 1: establishing a three-dimensional finite element model of the two-dimensional streamlined cross-section girder, analyzing geometric stiffness characteristics of the bridge girder in the vertical and torsional directions, and determining the overall law of stiffness variation with displacements and torsional angle.

Step 2: determining dynamic parameters of the bridge girder, including equivalent mass, moment of inertia and natural frequency, and determining geometric scale ratio, vibration frequency ratio and wind velocity ratio of a girder rigid model.

Step 3: establishing coupling motion equations of vertical and torsional degrees of freedom of the girder rigid model in a wind field, wherein the geometric stiffnesses are no longer constant but are functions of displacements.

Step 4: constructing a state equation, and converting the second order motion equations of vertical and torsional geometric stiffnesses into state-space form to conduct numerical integration solution and provide a computational basis for real-time update of the geometric stiffnesses varying with displacements.

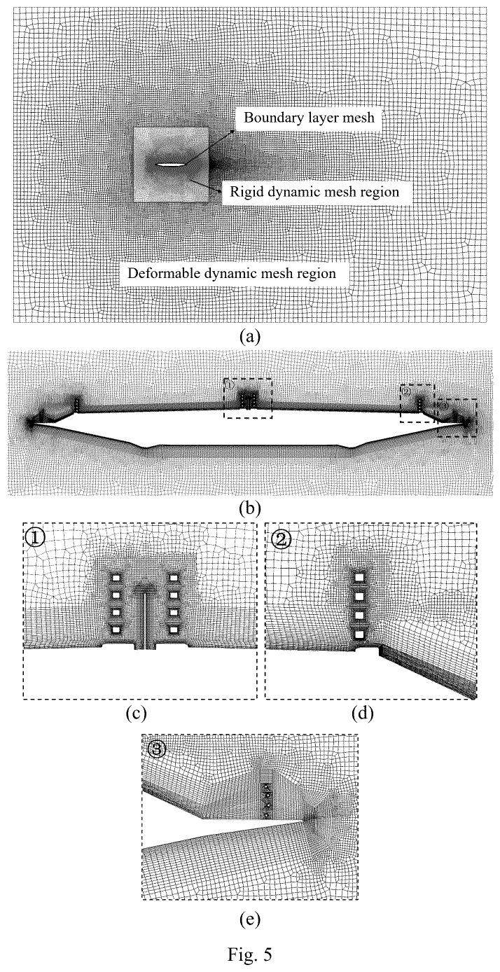

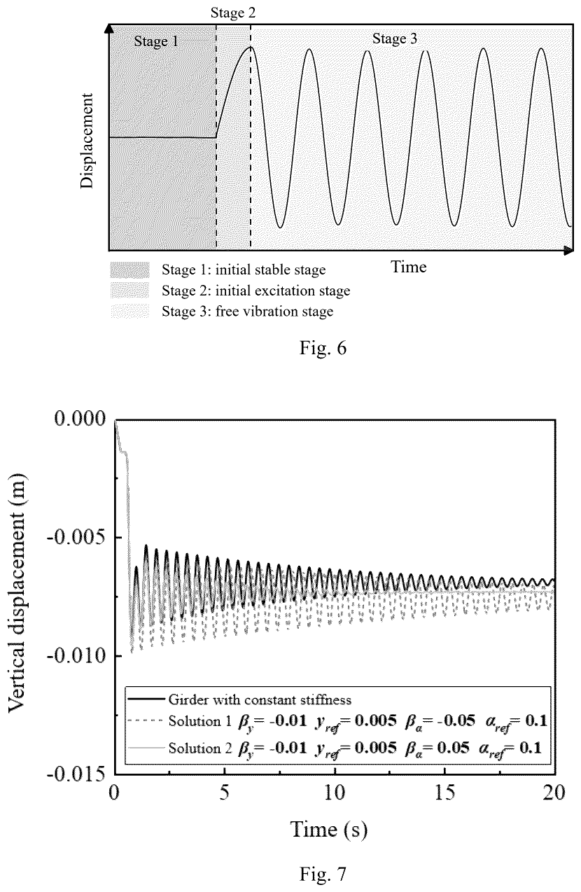

Step 5: establishing a computational domain and boundary conditions of a two-dimensional model of the two-dimensional streamlined bridge, as shown in FIG. 4. The computational domain is a two-dimensional rectangular wind field region, with a length of 3.75 m along the flow direction and a length of 2.5 m along the vertical direction. The origin of the coordinate system is located at the one-third position upstream the computational domain, 1.25 m away from the inlet, and 1.25 m away from the bottom and the top. The center of gravity of the two-dimensional model of the two-dimensional streamlined bridge coincides with the position of the origin, and the blocking rate is less than 1%. The left side of the computational domain is set as a velocity inlet boundary, the right side of the computational domain is set as a pressure outlet boundary, the upper and lower boundaries of the computational domain are set as symmetry boundaries, and the surface of the bridge girder is set as a no-slip wall boundary. Wind field computational domain mesh division comprises three parts, i.e., a near-wall boundary layer region, a rigid dynamic mesh region and a deformable dynamic mesh region, as shown in FIG. 5. Boundary layer region meshes are divided into 25 layers. The height of the first layer of the boundary layer region meshes is set as 0.00005 m and is increased layer by layer along the normal direction at an expansion rate of 1.1. The dynamic mesh region changing position with the motion of the bridge girder and the boundary layer region meshes is arranged outside the boundary layer region meshes; and the dynamic mesh region having position or shape updated with the motion of the structure implemented by a mesh smoothing algorithm is arranged further outside. The bidirectional transmission of velocity field and pressure field information among different regions is achieved through interfaces.

Step 6: importing the flow field meshes divided in step 5 into Fluent software, and embedding the state equation of nonlinear dynamic behaviors of the bridge girder and the nonlinear geometric stiffness model into the solver of the Fluent software by user defined functions (UDF) to achieve fluid-structure interaction (FSI) solution of the girder and the wind field. The specific process is as follows: (1) at the beginning of each time step, computing the nonlinear vertical geometric stiffness K_{y}(y,t) and torsional geometric stiffness K_{α}(α,t) based on the displacements and velocities of the bridge girder at the current time t, updating the state equation, and reading the vertical displacement and torsional displacement of the bridge girder at the current time t; computing the effective stiffnesses of the vertical and torsional degrees of freedom based on the current vertical displacement and torsional displacement of the bridge girder read and according to the preset nonlinear vertical geometric stiffness K_{y}(y,t) and torsional geometric stiffness K_{α}(α,t), thus to achieve the real-time variation of the nonlinear geometric stiffnesses with displacements; and (2) using updated nonlinear geometric stiffnesses, aerodynamic force F_{y}(t) and aerodynamic moment M(t) to solve the state equation of nonlinear dynamic behaviors of the bridge girder, and using a fourth order Runge-Kutta method to perform time-marching on the displacements and velocities, thus to obtain the displacement and velocity responses of the bridge girder at the current time step. Updated position of the bridge girder is fed back to a wind field computational domain through a dynamic mesh method, mesh update adopts a smoothing algorithm based on a diffusion equation, and displacement of a mesh node is inversely proportional to the 1.5th power of the minimum distance thereof to the surface of the girder, thus to maintain the mesh quality and numerical stability.

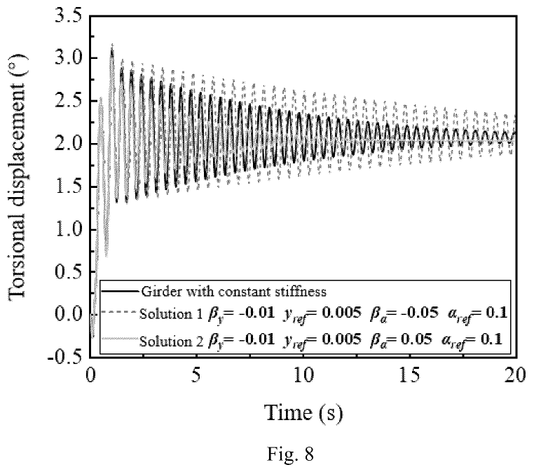

Step 7: at the initial stage of computation, keeping the girder in an approximately stationary state to ensure that the flow field is fully developed and reaches a stable distribution. Then applying an initial excitation (with a torsional angle of 2°) to the girder, and after the excitation is completed, repeating step 6 to solve the free vibration response of the structure. As the computation proceeds, the vertical and torsional displacement time histories of the girder in nonlinear geometric stiffness conditions can be obtained. FIG. 7 and FIG. 8 show the comparison of the vertical flutter and torsional flutter displacement time histories of girders with constant stiffnesses and girders with different nonlinear geometric stiffness functions at a wind speed of 5.9 m/s. It can be seen that the nonlinear geometric stiffnesses have a significant influence on the model response amplitude and the critical wind speed of flutter.

The protection scope of the present invention is not limited to the above embodiment. For those ordinary skilled in the art, equivalent replacement, improvement or deformation can be made to part of the technical features of the present invention according to the technical contents disclosed by the present invention without departing from the technical concept of the present invention. All such equivalent replacement, improvement or deformation shall be deemed to fall within the protection scope of the present invention.

1. A CFD numerical computational method for flutter responses of long-span bridges in nonlinear geometric stiffness conditions, implemented by the following steps:
step 1: establishing a three-dimensional finite element model of a bridge, and establishing a nonlinear geometric stiffness model based on computational analysis; and specifically:
establishing a functional relation between lateral geometric stiffness Kₓ(x,t) and lateral displacement x(t), a functional relation between vertical geometric stiffness K_{y}(y,t) and vertical displacement y(t), and a functional relation between torsional geometric stiffness K_{α}(α,t) and torsional displacement α(t) of the bridge;
step 2: determining dynamic parameters of a bridge girder, including equivalent mass, moment of inertia and natural frequency, and determining geometric scale ratio, vibration frequency ratio and wind velocity ratio of a girder rigid model;
step 3: establishing coupling motion equations of lateral, vertical and torsional degrees of freedom of the girder rigid model in a wind field; and during the motion of the bridge girder, dynamically adjusting the lateral geometric stiffness Kₓ(x,t), the vertical geometric stiffness K_{y}(y,t) and the torsional geometric stiffness K_{α}(α,t) with changes in time and displacements;
step 4: constructing a state equation to provide a computational basis for subsequent numerical integration solution and real-time update of the geometric stiffnesses varying with displacements;
step 5: establishing a geometric model of the bridge girder, determining the size and boundary conditions of a flow field computational domain, dividing flow field meshes, and reading the aerodynamic forces acting on the bridge girder and the probe position of a flow field in each flow field mesh cell;
step 6: importing the flow field meshes divided in step 5 into Fluent software, and embedding the state equation of nonlinear dynamic behaviors of the bridge girder and the nonlinear geometric stiffness model into the solver of the Fluent software by user defined functions (UDF) to achieve fluid-structure interaction (FSI) solution of the bridge girder and the wind field;
step 7: at the initial stage of computation, keeping the bridge girder in a stationary state to ensure that the flow field is fully developed and reaches a stable distribution; subsequently, applying an initial displacement excitation to the bridge girder as an initial condition of a free vibration stage; and in the free vibration stage, repeating step 6 for the bridge girder at each time step to solve the nonlinear flutter response time history of the bridge girder after excitation, thus to achieve numerical analysis of wind-induced flutter characteristics of the nonlinear geometric stiffnesses of the bridge.

2. The CFD numerical computational method for flutter responses of long-span bridges in nonlinear geometric stiffness conditions according to claim 1, wherein the “step 3: establishing coupling motion equations of lateral, vertical and torsional degrees of freedom of the girder rigid model in a wind field” is expressed as:
$$m \ddot{x} ( t ) + {C}_{x 0} \dot{x} ( t ) + {K}_{x 0} x ( t ) = {F}_{x} ( t ) \qquad ( 1 )$$
$$m \ddot{y} ( t ) + {C}_{y 0} \dot{y} ( t ) + {K}_{y 0} y ( t ) = {F}_{y} ( t ) \qquad ( 2 )$$
$$I \ddot{α} ( t ) + {C}_{a 0} \dot{α} ( t ) + {K}_{a 0} α ( t ) = M ( t ) \qquad ( 3 )$$
where m and I are respectively the equivalent mass and the moment of inertia of the girder rigid model; x(t), y(t) and α(t) are respectively the lateral displacement, the vertical displacement and the torsional displacement; \dot{x}(t), \dot{y}(t) and \dot{α}(t) are respectively the lateral velocity, the vertical velocity and the torsional angular velocity; \ddot{x}(t), ÿ(t) and \ddot{α}(t) are respectively the lateral acceleration, the vertical acceleration and the torsional angular acceleration; Fₓ(t), F_{y}(t) and M(t) are respectively the aerodynamic forces in the lateral and vertical directions and the aerodynamic moment in the torsional direction; Cₓ₀, C_{y0} and C_{α0} are respectively the damping coefficients in the lateral, vertical and torsional directions; Kₓ₀, K_{y0} and K_{α0} are respectively the initial stiffnesses in the lateral, vertical and torsional directions; and the expressions are as follows:
$${C}_{x 0} = 2 m \cdot {ω}_{x 0} \cdot {ξ}_{x 0} \qquad ( 4 )$$
$${C}_{y 0} = 2 m \cdot {ω}_{y 0} \cdot {ξ}_{y 0} \qquad ( 5 )$$
$${C}_{α0} = 2 I \cdot {ω}_{α0} \cdot {ξ}_{α0} \qquad ( 6 )$$
$${K}_{x 0} = m {ω}_{x 0}^{2} \qquad ( 7 )$$
$${K}_{y 0} = m {ω}_{y 0}^{2} \qquad ( 8 )$$
$${K}_{α0} = I {ω}_{α0}^{2} \qquad ( 9 )$$
where ωₓ₀, ω_{y0} and ω_{α0} are respectively the natural frequencies in the lateral, vertical and torsional directions; and ξₓ₀, ξ_{y0} and ξ_{α0} are respectively the mechanical damping ratios in the lateral, vertical and torsional directions;
during the motion of the bridge girder, dynamically adjusting the lateral geometric stiffness Kₓ(x,t), the vertical geometric stiffness K_{y}(y,t) and the torsional geometric stiffness K_{α}(α,t) with changes in time and displacements;
computing the lateral displacement x(t), the vertical displacement y(f) and the torsional displacement α(t) in the user defined functions (UDF) in real time, and dynamically updating the lateral geometric stiffness Kₓ(x,t), the vertical geometric stiffness K_{y}(y,t) and the torsional geometric stiffness K_{α}(α,t) to achieve real-time adjustment of the geometric stiffnesses with changes in displacements;
replacing the initial stiffnesses Kₓ₀, K_{y0} and K_{α0} in the lateral, vertical and torsional directions in equations (1), (2) and (3) with the nonlinear lateral, vertical and torsional geometric stiffnesses Kₓ(x,t), K_{y}(y,t) and K_{α}(α,t) considering the variation of the geometric stiffnesses with changes in time and displacements, and rewriting equations (1), (2) and (3) as:
$$\ddot{x} ( t ) = [ {F}_{x} ( t ) - {C}_{x 0} \dot{x} ( t ) - {K}_{x} ( x , t ) x ( t ) ] / m \qquad ( 10 )$$
$$\ddot{y} ( t ) = [ {F}_{y} ( t ) - {C}_{y 0} \dot{y} ( t ) - {K}_{y} ( y , t ) y ( t ) ] / m \qquad ( 11 )$$
$$\ddot{α} ( t ) = [ M ( t ) - {C}_{α0} \dot{α} ( t ) - {K}_{α} ( α , t ) α ( t ) ] / I \qquad ( 12 )$$

3. The CFD numerical computational method for flutter responses of long-span bridges in nonlinear geometric stiffness conditions according to claim 2, wherein constructing a state equation in step 4 is specifically as follows:
letting X(t)=[x(t), y(t), α(t), x(t), y(t), α(t)]^{T}, and rewriting the second order differential equations (10), (11) and (12) as the following first order differential equation:
$$\dot{X} ( t ) = ( \begin{matrix}\dot{x} ( t ) \\ \dot{y} ( t ) \\ \dot{α} ( t ) \\ \ddot{x} ( t ) \\ \ddot{y} ( t ) \\ \ddot{α} ( t )\end{matrix} ) = ( \begin{matrix}0 & 0 & 0 & 1 & 0 & 0 \\ 0 & 0 & 0 & 0 & 1 & 0 \\ 0 & 0 & 0 & 0 & 0 & 1 \\ - \frac{{K}_{x} ( x , t )}{m} & 0 & 0 & - \frac{{C}_{x 0}}{m} & 0 & 0 \\ 0 & - \frac{{K}_{y} ( y , t )}{m} & 0 & 0 & - \frac{{C}_{y 0}}{m} & 0 \\ 0 & 0 & - \frac{{K}_{α} ( α , t )}{I} & 0 & 0 & - \frac{{C}_{α 0}}{I}\end{matrix} ) ( \begin{matrix}x ( t ) \\ y ( t ) \\ α ( t ) \\ \dot{x} ( t ) \\ \dot{y} ( t ) \\ \dot{α} ( t )\end{matrix} ) + {( \begin{matrix}0 & 0 & 0 & \frac{{F}_{x} ( t )}{m} & \frac{{F}_{y} ( t )}{m} & \frac{M ( t )}{I}\end{matrix} )}^{T} = AX ( t ) + B \qquad ( 13 )$$
equation (13) is the state equation describing the nonlinear dynamic behaviors of the bridge girder in the wind field; and in a numerical simulation process, after the aerodynamic forces and aerodynamic torque acting on the bridge girder in each time step are obtained, a fourth order Runge-Kutta numerical integration algorithm is adopted based on the state equation to solve the time-domain evolution of a system state, and displacement responses x(t), y(t) and α(t) as well as velocity responses \dot{x}(t), \dot{y}(t) and \dot{α}(t) of the bridge girder under wind-induced excitation are obtained.

4. The CFD numerical computational method for flutter responses of long-span bridges in nonlinear geometric stiffness conditions according to claim 3, wherein the specific implementation process of step 5 is as follows: the computational domain adopted is a rectangular wind field region arranged around the bridge girder, and the boundary conditions are set, including setting a velocity inlet boundary, setting a pressure outlet boundary, setting upper and lower boundaries of the computational domain as symmetrical boundary conditions, and setting the surface of the bridge girder as a no-slip wall boundary; meshes of the computational domain adopt a mesh structure comprising a near-wall encrypted boundary layer region and a dynamic mesh region having position or shape updated with the motion of the bridge girder; and the update of the dynamic mesh region is implemented by a mesh smoothing method.

5. The CFD numerical computational method for flutter responses of long-span bridges in nonlinear geometric stiffness conditions according to claim 4, wherein the specific implementation process of step 6 is as follows:
1) at the beginning of each time step, computing the lateral geometric stiffness Kₓ(x,t), the vertical geometric stiffness K_{y}(y,t) and the torsional geometric stiffness K_{α}(α,t) based on the displacements and velocities of the bridge girder at the current time t, updating the state equation (13), and reading updated lateral displacement, vertical displacement and torsional displacement of the bridge, thus to achieve the real-time variation of the nonlinear geometric stiffnesses with displacements;
2) using updated lateral geometric stiffness, vertical geometric stiffness and torsional geometric stiffness as well as the aerodynamic forces to solve the state equation of the bridge girder, and using a fourth order Runge-Kutta method to perform time-marching on the displacements and velocities;
3) updating the position of the bridge girder and automatically adjusting the meshes of a wind field computational domain to maintain the consistency of fluid-structure interaction (FSI).
